(19) United States
(12) Patent Application Publication
(10) Pub. No.: US 2017/0362061 A1
(43) Pub. Date: Dec. 21, 2017

(54) TRANSFER STATION AND CAR DISENGAGEMENT MECHANISM FOR A ROPELESS ELEVATOR SYSTEM

(71) Applicant: OTIS ELEVATOR COMPANY, Farmington, CT (US)

(72) Inventors: Tadeusz Witczak, Farmington, CT (US); Bryan Robert Siewert, Clinton, CT (US); Cezary Jedryczka, Lniano (PL); Adam Martin Myszkowski, Ostrow Wlkp (PL); Wojciech Szelag, Poznan (PL); Enrico Manes, Feeding Hills, MA (US); Zbigniew Piech, Cheshire, CT (US)

(21) Appl. No.: 15/539,967

(22) PCT Filed: Dec. 29, 2015
(86) PCT No.: PCT/US2015/067827

§ 371 Date: Jun. 26, 2017

Related U.S. Application Data
(60) Provisional application No. 62/098,035, filed on Dec. 30, 2014.

(51) Int. Cl. B66B 9/00; B66B 9/02; B66B 11/00; B66B 11/04

(52) U.S. Cl. CPC B66B 9/003; B66B 11/0407; B66B 9/02; B66B 11/005

(57) ABSTRACT

A transfer station (40) for a ropeless elevator system includes a plurality of lanes (13) configured to accommodate vertical travel of an elevator car (14) therein. Also included is a parking area (42) located adjacent at least one of the plurality of lanes (13). Further included is a carriage (46) moveable between the plurality of lanes (13) and the parking area (42), the carriage (46) configured to support and move the elevator car (14) in a horizontal direction. Yet further included is a car (14) disengagement mechanism (50) engageable with the elevator car (14) for disengagement of the elevator car (14) from a primary propulsion mechanism of the car (14) within the plurality of lanes (13) and for movement of the elevator car (14) between at least one of the plurality of lanes (13) and the parking area (42).

### FIELD OF THE INVENTION

The subject matter disclosed herein relates generally to the field of elevators, and more particularly to a multicar, ropeless elevator system.

### BACKGROUND OF THE INVENTION

Ropeless elevator systems, also referred to as self-propelled elevator systems, are useful in certain applications (e.g., high rise buildings) where the mass of the ropes for a roped system is prohibitive and there is a desire for multiple elevator cars to travel in a single lane. There exist ropeless elevator systems in which a first lane is designated for upward traveling elevator cars and a second lane is designated for downward traveling elevator cars with at least two transfer stations in the hoistway used to move cars horizontally between the first lane and second lane.

Transfer stations do not typically provide redundancy for transfer station operation. Therefore, the numbers of structures capable of moving elevator cars is equal to or lower than the number of lanes of the hoistway. The assumption is that in a worst case scenario, independent working carriages in the transfer station may work with a reduced number of carriages. Working with a reduced number of carriages decreases overall elevator system efficiency and may cause operation delays, as well as logistical challenges.

### BRIEF DESCRIPTION OF THE INVENTION

According to one aspect of the invention, a transfer station for a ropeless elevator system includes a plurality of lanes configured to accommodate vertical travel of an elevator car therein. Also included is a parking area located adjacent at least one of the plurality of lanes. Further included is a carriage moveable between the plurality of lanes and the parking area, the carriage configured to support and move the elevator car in a horizontal direction. Yet further included is a car disengagement mechanism engageable with the elevator car for disengagement of the elevator car from a primary propulsion mechanism of the car within the plurality of lanes and for movement of the elevator car between at least one of the plurality of lanes and the parking area.

In addition to one or more of the features described above, or as an alternative, further embodiments may include that the car disengagement mechanism comprises a car lifting mechanism that is secondary to the primary propulsion mechanism.

In addition to one or more of the features described above, or as an alternative, further embodiments may include that a parking mechanism is located in the parking area and configured to receive the elevator car from the car disengagement mechanism.

In addition to one or more of the features described above, or as an alternative, further embodiments may include that the car disengagement mechanism is coupled to the carriage.

In addition to one or more of the features described above, or as an alternative, further embodiments may include that the car disengagement mechanism and the carriage are moveable between the parking area and at least one of the plurality of lanes.

In addition to one or more of the features described above, or as an alternative, further embodiments may include that the parking mechanism is at least one propelled pallet.

In addition to one or more of the features described above, or as an alternative, further embodiments may include that the parking mechanism enters one of the plurality of lanes to receive the elevator car for movement to the parking area, the car disengagement mechanism disposed in one of the parking area and the plurality of lanes.

In addition to one or more of the features described above, or as an alternative, further embodiments may include that the car disengagement mechanism is independently moveable relative to the carriage.

In addition to one or more of the features described above, or as an alternative, further embodiments may include that the car disengagement mechanism includes an independent propulsion mechanism to control movement of the car disengagement mechanism.

In addition to one or more of the features described above, or as an alternative, further embodiments may include that the independent propulsion mechanism comprises at least one of an electric motor, a belt and a chain.

In addition to one or more of the features described above, or as an alternative, further embodiments may include that the car disengagement mechanism engages the elevator car one floor away from the transfer station.

In addition to one or more of the features described above, or as an alternative, further embodiments may include that the elevator car is movable with the carriage and the car disengagement mechanism on floors of the plurality of lanes that are not the transfer station floor.

According to another aspect of the invention, a transfer station for a ropeless elevator system includes a plurality of lanes configured to accommodate vertical travel of an elevator car therein. Also included is a parking area located adjacent at least one of the plurality of lanes. Further included is a carriage moveable between the plurality of lanes, the carriage configured to support and move the elevator car in a horizontal direction. Yet further included is a car disengagement mechanism located within at least one of a terminal of the parking area and the plurality of lanes, the car disengagement mechanism engageable with the elevator car for movement of the elevator car within the parking area.

In addition to one or more of the features described above, or as an alternative, further embodiments may include that the carriage is moveable from the plurality of lanes to the parking area to transfer to the elevator car to the car disengagement mechanism.

According to another aspect of the invention, a method of moving an elevator car within a transfer station region is provided. The method includes moving the elevator car in a vertical direction within a plurality of lanes of a hoistway. The method also includes supporting the elevator car with a carriage located within the plurality of lanes. The method further includes disengaging a primary propulsion mechanism configured to move the elevator car within the plurality of lanes. The method yet further includes moving the elevator car with the carriage. The method also includes transferring the elevator car from one of the plurality of lanes to a parking area located adjacent the plurality of lanes with a car disengagement mechanism.

In addition to one or more of the features described above, or as an alternative, further embodiments may include moving the car disengagement mechanism independently relative to the carriage.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a multicar ropeless elevator system according to one aspect of the invention;

FIG. 2 is a schematic illustration of one car of the multicar ropeless elevator system;

FIG. 3 is a perspective view of a transfer station of the multicar ropeless elevator system according to one embodiment;

FIG. 4 is a perspective view of the transfer station according to another embodiment;

FIG. 5 is a perspective view of a transfer station with an independent forklift for moving cars of the multicar ropeless elevator system; and

FIG. 6 is a perspective view of a transfer with a forklift coupled to a carriage of the multicar ropeless elevator system.

The detailed description explains embodiments of the invention, together with advantages and features, by way of example with reference to the drawings.

### DETAILED DESCRIPTION OF THE INVENTION

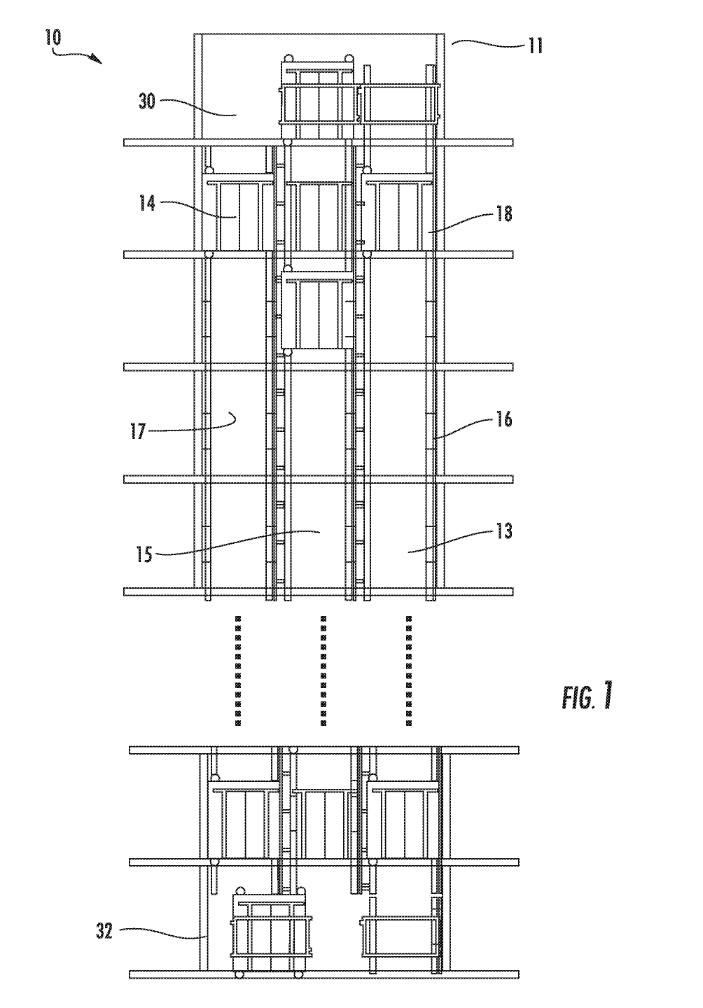

Referring to FIG. 1, a multicar, ropeless elevator system 10 is illustrated according to one embodiment. Elevator system 10 includes a hoistway 11 having a plurality of lanes 13, 15 and 17. While three lanes are shown in FIG. 1, it is understood that embodiments may be used with multicar, ropeless elevator systems that have any number of lanes. In each lane 13, 15, 17, cars 14 travel in one direction, i.e., up or down. For example, in FIG. 1 cars 14 in lanes 13 and 17 travel up and cars 14 in lane 15 travel down. One or more cars 14 may travel in a single lane 13, 15, and 17.

Above the top floor is an upper transfer station 30 to impart horizontal motion to elevator cars 14 to move elevator cars 14 between lanes 13, 15 and 17. It is understood that upper transfer station 30 may be located at the top floor, rather than above the top floor. Below the first floor is a lower transfer station 32 to impart horizontal motion to elevator cars 14 to move elevator cars 14 between lanes 13, 15 and 17. It is understood that lower transfer station 32 may be located at the first floor, rather than below the first floor. Although not shown in FIG. 1, one or more intermediate transfer stations may be used between the lower and the upper transfer station floors. Intermediate transfer stations are similar to the upper transfer station 30 and lower transfer station 32. Additionally, both the upper transfer station 30 and the lower transfer station 32 may be at system terminals, or at any floor above or below. Therefore, it is to be understood that an upper transfer station is meant to be the highest placed transfer station in the loop and a bottom transfer station is the lowest transfer station in the loop. Transfer stations at various locations advantageously impact the functional capability of the system by increasing loop options. For example, the lanes may include cars traveling in a unidirectional or bidirectional manner. Furthermore, parking of the cars may be performed in transfer stations depending on the particular location and configuration

Cars 14 are self-propelled using, for example, a linear motor system having a fixed portion 16 and a moving portion 18. One or more fixed portions 16 are mounted in lanes 13, 15 and 17. Fixed portion 16 may include coils that are energized by one or more drives to produce magnetic flux. Moving portion 18 may include permanent magnets that co-act with the coils 26 to impart force on car 14. One or more moving portions 18 are mounted on cars 14. One of the motor portions is supplied with drive signals to control movement of cars 14 in their respective lanes.

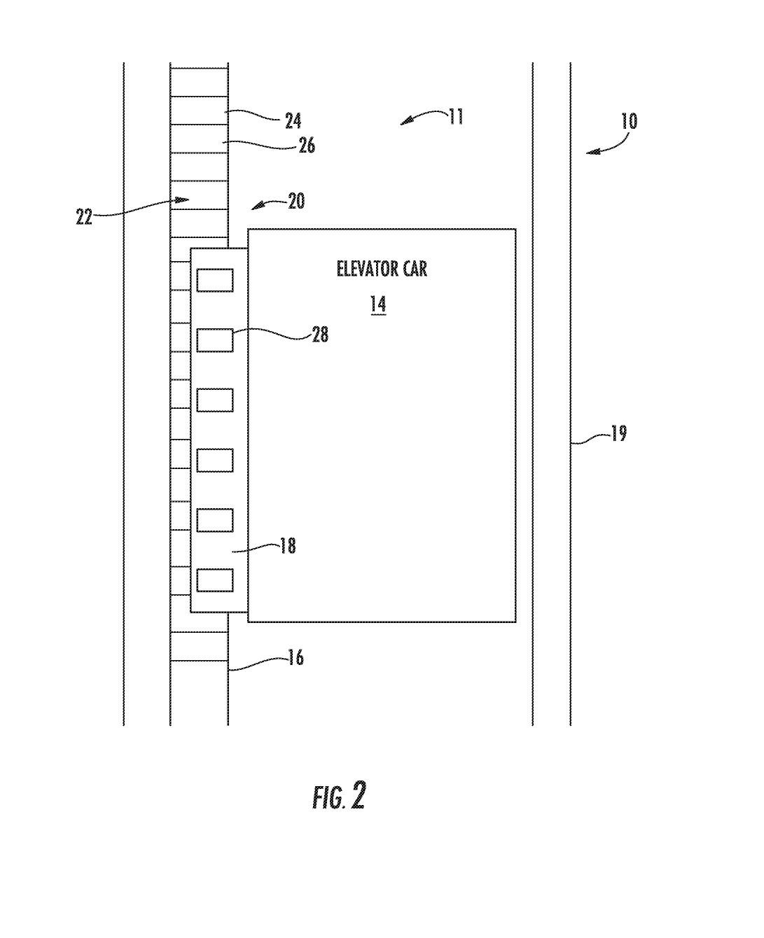

Referring to FIG. 2, illustrated is another view of the elevator system 10 including an elevator car 14 that travels in hoistway 11. Elevator car 14 is guided by one or more guide structure 24 extending along the length of hoistway 11, where the guide structure 24 may be affixed to hoistway wall, propulsion device, carriage structural member 19, or stacked over each other. For ease of illustration, the view of FIG. 2 only depicts a single side guide structure 24; however, there may be two or more guide structure 24 positioned, for example, on opposite sides of the elevator car 14. Elevator system 10 employs a vertical propulsion system 20, where same placement variations apply to vertical propulsion stationary portion 16 placed in the hoistway. Vertical propulsion stationary portion 16 includes multiple segments 22. Segments 22 may be affixed to hoistway wall, guide structure, carriage structural member 19, or stacked over each other. Propulsion moving portion 18 may be affixed to a car frame or be a structural member of a car frame. A number of propulsion moving portions 18 may be placed on a car.

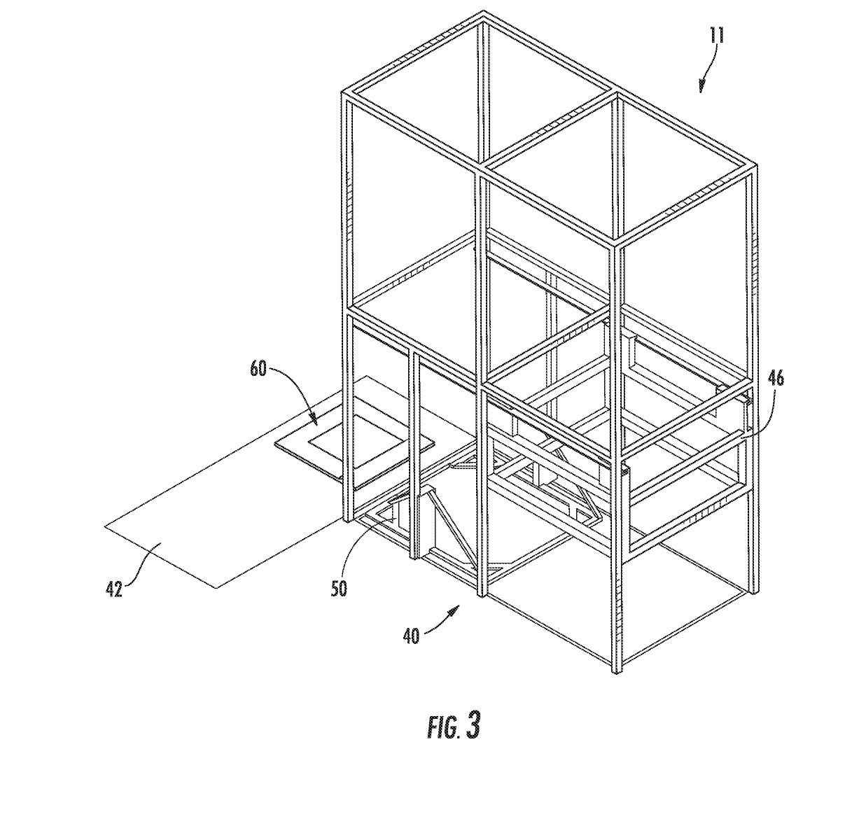

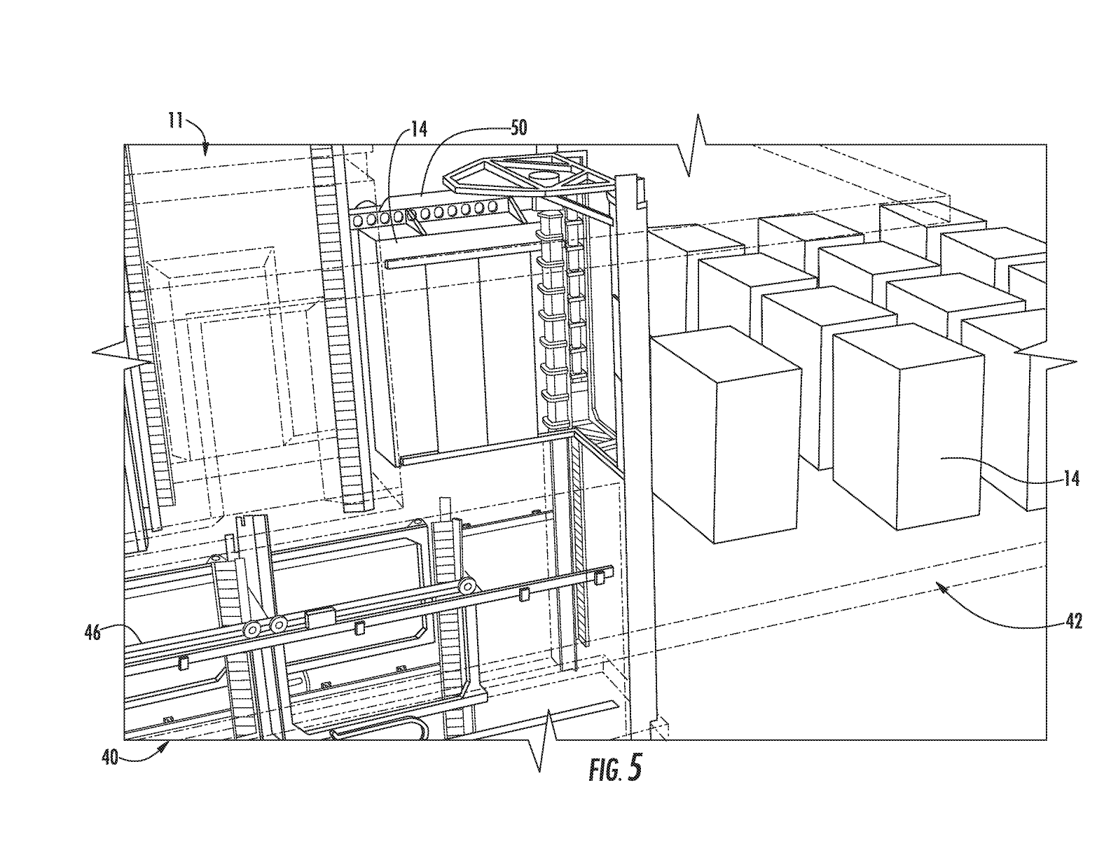

Referring now to FIGS. 3-6, with continued reference to FIGS. 1 and 2, a transfer station 40 is illustrated. The illustrated transfer station 40 may be positioned at any vertical location within the hoistway 11. For example, the transfer station 40 may be the upper transfer station 30, the lower transfer station 32, or an intermediate transfer station located between two of them. The transfer station 40 is a location where the elevator cars 14 may be moved (horizontally and/or vertically) to transfer the cars 14 between the lanes 13, 15, 17 and between a parking and/or storage area 42.

Transport of the cars 14 is made with a frame-like structure referred to as a carriage 46. The carriages 46 may be used to park or store elevator cars 14 in a manner that allows disengagement of the cars from the guiding structures within the hoistway. The carriages 46 may or may not be moved out of the lanes 13, 15, 17 and move horizontally and/or vertically. The carriages may be configured to allow the elevator cars 14 to pass through the frame-like structures, such that the carriages may be positioned in the middle lanes during normal operation of the elevator system 10. This alleviates the need to maintain the carriages out of the lanes until they are needed. The number of carriages 46 at each transfer station may vary, such that the number of carriages may be equal to or less than the number of lanes.

Parking of the cars 14 may be done for varied amounts of time. Increasing or decreasing the number of cars 14 actively circulating within the lanes is desirable based on the varying levels of use of the hoistway during certain times of the day. For example, during non-peak usage hours, it is desirable to reduce the number of cars circulating by moving some of the cars to the parking area 42. Conversely, during peak usage hours, it is desirable to increase the number of cars circulating by moving some of the cars from the parking area 42 to the lanes 13, 15, 17.

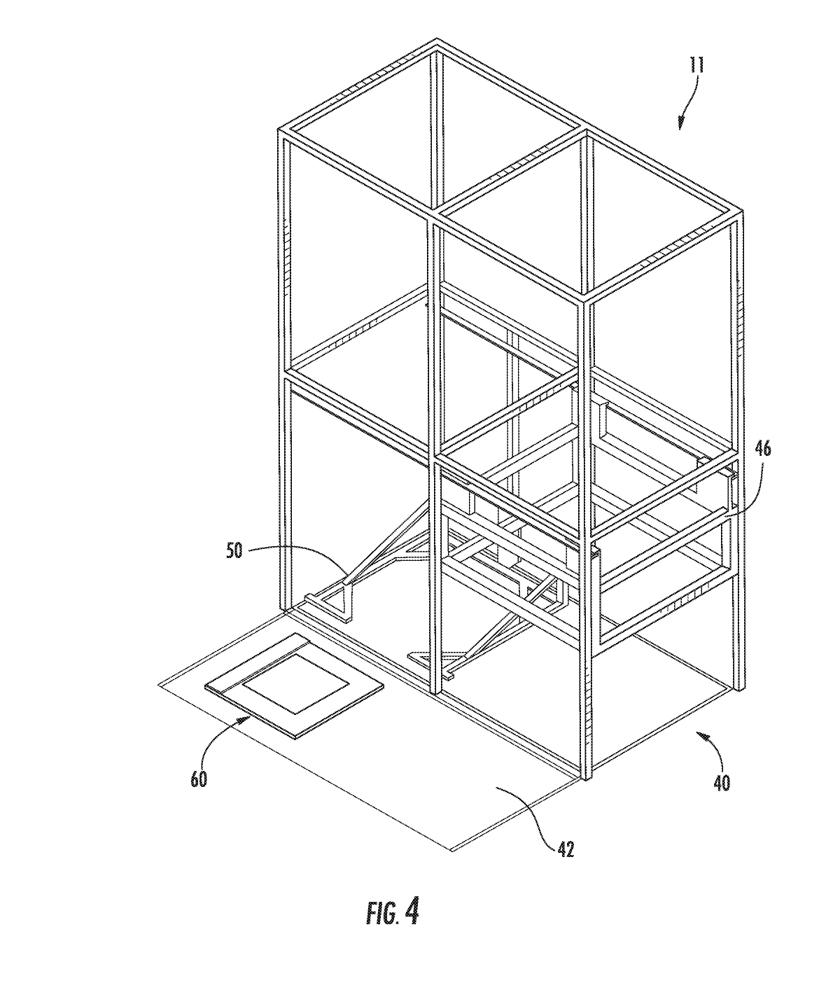

Additionally, movement of the cars to the parking area 42 facilitates maintenance of the cars 14, if needed. It is to be understood that although a single parking area is discussed and illustrated, multiple parking areas may be included at each transfer station 40. For example, a parking area may be located adjacent more than one of the lanes 13, 15, 17. In the illustrated embodiment of FIG. 3, a “L-shaped” transfer station is shown based on the combined layout of the parking area 42 and the lanes. By way of another non-limiting example, FIG. 4 illustrates a “rectangular” or “square-shaped” transfer station based on the combined layout of the parking area 42 and the lanes. These are merely examples and it is to be appreciated that numerous other layouts are contemplated. It is further contemplated that the elevator cars are moveable in a horizontal or vertical manner with the carriage and/or car disengagement mechanism on floors that are not a transfer station floor.

As described herein, a car disengagement mechanism is provided to move and/or support the elevator cars 14. Disengagement is meant to be understood as separation of stationary and moving parts of motor as well as guiding structure from rails. In one embodiment, the car disengagement mechanism is a forklift 50, but it is to be appreciated that any mechanism may be employed to disengage the elevator car 14 from the primary propulsion system to remove the elevator car from the lane(s) and into a parking area. The forklift 50 of the illustrated embodiment of FIGS. 3-5 is independently moveable relative to the carriage 46. In this way, the forklift 50 may retrieve the elevator car 14 as a transition from the carriage 46 or may engage the elevator car 14 without the need for the carriage 46. The forklift 50 may become a redundancy to the carriage 46 and may pick cars from any lane, as well as the floor above, to transport the elevator car 14 to the parking are where it may pass the elevator car to a storage mechanism or place the car in the storage itself. As shown, the forklift 50 may be moveable in a vertical and/or horizontal manner to engage the elevator car 14 and to facilitate transfer to the parking area 42. Once disengagement of the elevator car from the primary propulsion system is made, the car may be moved as desired. In one embodiment, the forklift 50 is always disposed within one of the lanes. In such an embodiment, a parking mechanism 60 in the form of a pallet or the like moves into the lane to receive the elevator car from the forklift 50. All or a portion of the parking mechanism 60 may be moved into the lane during such a maneuver. Upon engagement of the elevator car 14 and the parking mechanism 60, the elevator car is moved out of the lane to the parking area 42 and may be moved to a desired location within the parking area 42.

In another embodiment, the forklift 50 moves the elevator car 14 out of the lane to the parking area 42. Upon removal from the lane, the forklift 50 maneuvers the elevator car 14 onto the parking mechanism 60.

In yet another embodiment of an independently moveable forklift 50, the forklift 50 may be positioned outside of the lane, such that the forklift 50 is not aligned in a vertical direction with any of the lanes. In such an embodiment, the forklift 50 reaches into the lane with engagement members to retrieve the elevator car 14 and to move it to the parking area 42.

In each of the embodiments of an independently moveable forklift 50, an independent propulsion mechanism is employed to control movement of the forklift 50. The propulsion mechanism may be an electric motor, a belt, a chain or the like, as is the case with the carriage 46.

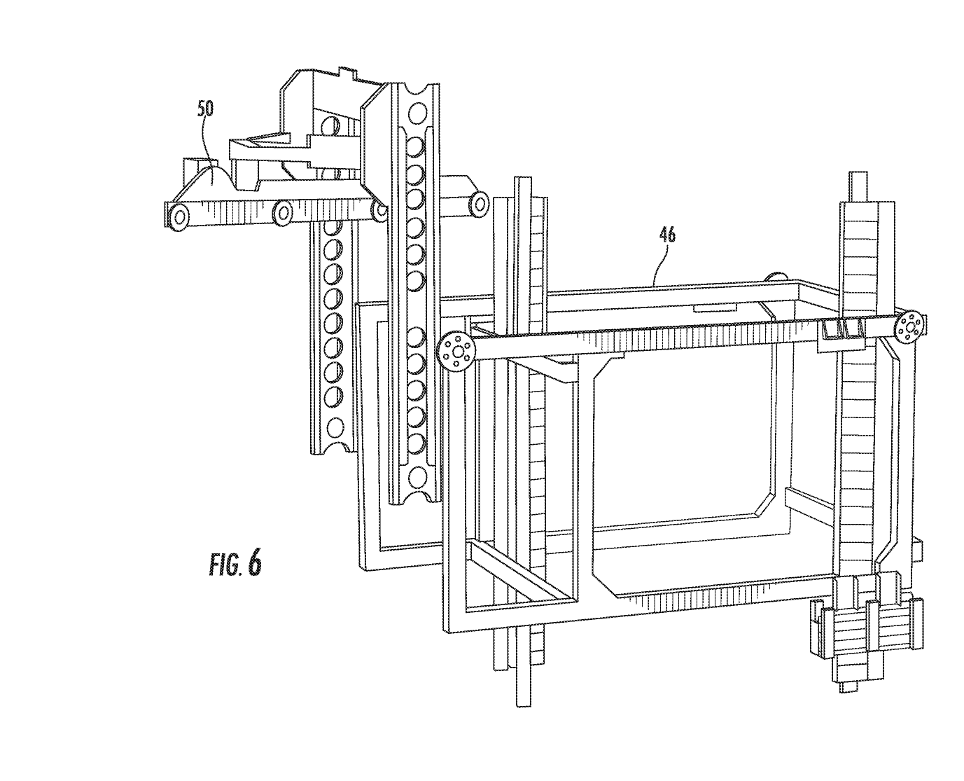

In the embodiment illustrated in FIG. 6, the forklift 50 is coupled to the carriage 46. A fixed coupling between the forklift 50 and the carriage 46 allows movement of the forklift 50 and the carriage 46 as a single unit for movement of the elevator cars 14. In such an embodiment, the carriage 46 and the forklift 50 may both be moved to the parking area 42 for movement of the elevator car 14. Alternatively, the parking mechanism 60 may enter the lanes to engage the elevator car 14 for movement into the parking area 42 while the carriage 46 and the forklift 50 remain in the lanes.

In all of the above-described embodiments, the forklift 50 facilitates removal of elevator cars during normal operation of the overall system. In particular, in combination with the carriage 46, which allows rapid disengagement of the elevator cars from the main guiding and propulsion components, a car is rapidly removed in an efficient manner. This is highly advantageous to perform maintenance on the elevator cars and to modify the number of cars circulating throughout the lanes during time periods with different operational needs (i.e., peak vs. non-peak hours).

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A transfer station for a ropeless elevator system comprising:
a plurality of lanes configured to accommodate vertical travel of an elevator car therein;
a parking area located adjacent at least one of the plurality of lanes;
a carriage moveable between the plurality of lanes and the parking area, the carriage configured to support and move the elevator car in a horizontal direction; and
a car disengagement mechanism engageable with the elevator car for disengagement of the elevator car from a primary propulsion mechanism of the car within the plurality of lanes and for movement of the elevator car between at least one of the plurality of lanes and the parking area.

2. The transfer station of claim 1, wherein the car disengagement mechanism comprises a car lifting mechanism that is secondary to the primary propulsion mechanism.

3. The transfer station of claim 1, wherein a parking mechanism is located in the parking area and configured to receive the elevator car from the car disengagement mechanism.

4. The transfer station of claim 1, wherein the car disengagement mechanism is coupled to the carriage.

5. The transfer station of claim 4, wherein the car disengagement mechanism and the carriage are moveable between the parking area and at least one of the plurality of lanes.

6. The transfer station of claim 3, wherein the parking mechanism is at least one propelled pallet.

7. The transfer station of claim 3, wherein the parking mechanism enters one of the plurality of lanes to receive the elevator car for movement to the parking area, the car disengagement mechanism disposed in one of the parking area and the plurality of lanes.

8. The transfer station of claim 1, wherein the car disengagement mechanism is independently moveable relative to the carriage.

9. The transfer station of claim 8, wherein the car disengagement mechanism includes an independent propulsion mechanism to control movement of the car disengagement mechanism.

10. The transfer station of claim 9, wherein the independent propulsion mechanism comprises at least one of an electric motor, a belt and a chain.

11. The transfer station of claim 1, wherein the car disengagement mechanism engages the elevator car one floor away from the transfer station.

12. The transfer station of claim 1, wherein the elevator car is movable with the carriage and the car disengagement mechanism on floors of the plurality of lanes that are not the transfer station floor.

13. A transfer station for a ropeless elevator system comprising:
a plurality of lanes configured to accommodate vertical travel of an elevator car therein;
a parking area located adjacent at least one of the plurality of lanes;
a carriage moveable between the plurality of lanes, the carriage configured to support and move the elevator car in a horizontal direction; and
a car disengagement mechanism located within at least one of a terminal of the parking area and the plurality of lanes, the car disengagement mechanism engageable with the elevator car for movement of the elevator car within the parking area.

14. The transfer station of claim 13, wherein the carriage is moveable from the plurality of lanes to the parking area to transfer to the elevator car to the car disengagement mechanism.

15. A method of moving an elevator car within a transfer station region comprising:
moving the elevator car in a vertical direction within a plurality of lanes of a hoistway;
supporting the elevator car with a carriage located within the plurality of lanes;
disengaging a primary propulsion mechanism configured to move the elevator car within the plurality of lanes;
moving the elevator car with the carriage; and
transferring the elevator car from one of the plurality of lanes to a parking area located adjacent the plurality of lanes with a car disengagement mechanism.

16. The method of claim 15, further comprising moving the car disengagement mechanism independently relative to the carriage.
